(19) United States
(12) Patent Application Publication
(10) Pub. No.: US 2022/0258624 A1
(43) Pub. Date: Aug. 18, 2022

(54) System For Use In Docking And Charging Micro-Mobility Electric Vehicles

(71) Applicant: Kuhmute Inc., Almont, MI (US)

(72) Inventors: Peter Deppe, Almont, MI (US); Scott Spitler, Flint, MI (US)

(73) Assignee: Kuhmute Inc, Almont, MI (US)

(21) Appl. No.: 17/628,914

(22) PCT Filed: Jul. 22, 2020
(86) PCT No.: PCT/US2020/042973

§ 371 Date: Jan. 21, 2022

Related U.S. Application Data
(60) Provisional application No. 62/876,916, filed on Jul. 22, 2019.

(51) Int. Cl. B60L 53/14; B60L 53/31; B60L 53/66; B60L 53/30; B60L 53/36

(52) U.S. Cl. CPC B60L 53/14; B60L 53/31; B60L 53/66; B60Y 2200/91; B60L 53/36; B60L 2200/12; B60L 53/305

(57) ABSTRACT

A system for docking an electric vehicle and for charging a battery of the electric vehicle via a power source. The system includes a coupler having a housing adapted for attaching to the electric vehicle, a vehicle power terminal for interfacing with the battery of the electric vehicle, and a catch. The system further includes a hub having a receiver shaped to engage the housing of the coupler, a hub power terminal for interfacing with the power source, and a latch supported for movement between an extended position to limit movement of the coupler relative to the hub and a released position where the latch is spaced from the catch to permit movement of the coupler relative to the hub, wherein movement of the housing into the receiver aligns the catch with the latch to move the latch to the extended position.

### CROSS-REFERENCE TO RELATED APPLICATION

The subject patent application claims priority to and all the benefits of U.S. Provisional Patent Application No. 62/876,916 filed on Jul. 22, 2019, the disclosure of which is hereby incorporated by reference in its entirety.

### BACKGROUND

Micro-mobility electric vehicles, such as electric bicycles, electric scooters, electric wheelchairs, electric skateboards, and the like, are an increasingly popular mode of personal transportation in urban and other environments. Conventional micro-mobility electric vehicles are typically battery powered, and provide the advantages of reducing automobile traffic, decreasing air/noise pollution, increasing energy efficiency, and providing a socially-distant alternative to public transportation. While micro-mobility electric vehicles are available for private ownership, many micro-mobility electric vehicles are part of fleets that are available for short-term rental, or may be available for public use.

While micro-mobility electric vehicles provide a number of different advantages, their utilization also presents various challenges for owners, fleet operators, and the municipalities in which micro-mobility electric vehicles are utilized. For example, charging the batteries of micro-mobility electric vehicles can present significant logistical challenges. Most micro-mobility vehicles may be charged using typical alternating current (AC) to direct current (DC) chargers that plug into conventional AC wall outlets. When utilized in connection with a fleet system, micro-mobility electric vehicles may be located in various locations (e.g., across a city), and may need to be charged in different locations. With relatively large fleets, it can become difficult to track the location, condition, status, and/or availability of each fleet-operated micro-mobility electric vehicle. Furthermore, theft is also a concern, particularly when vehicles are left unattended at a charging station.

When utilized as a privately-owned micro-mobility electric vehicle, additional challenges may be presented. It will be appreciated that conventional AC wall outlets are often not widely available in desirable public locations where an owner may want to leave their micro-mobility electric vehicle for charging. In any event, owners may be required to transport their own AC to DC charger, which could likewise be stolen if left unattended. Moreover, while some types of charging stations do allow for privately-owned micro-mobility electric vehicles to be charged, they may only be compatible with certain charging parameters, interfaces, and the like, and may only be compatible with a limited number of types or brands of micro-mobility electric vehicles.

Additionally, micro-mobility vehicles themselves can present a significant source of clutter, as many fleet operators allow vehicles to be scattered across city streets without any meaningful storage options. For example, micro-mobility electric vehicle users may leave vehicles piled-up at popular destinations where there are no orderly storage options, leading to physical and aesthetic clutter.

Accordingly, there remains a need in the art for overcoming one or more of the aforementioned challenges.

### SUMMARY

The present disclosure provides a system for use in docking an electric vehicle and for charging a battery of the electric vehicle via a power source. The system includes a coupler having a housing adapted for attaching to the electric vehicle, a vehicle power terminal supported by the housing for interfacing with the battery of the electric vehicle, and a catch spaced from the vehicle power terminal. The system also includes a hub having a receiver shaped to engage the housing of the coupler, and a hub power terminal supported by the receiver for interfacing with the power source. The hub power terminal is arranged to abut the vehicle power terminal when the receiver engages the housing of the coupler. The hub also has a latch having an engagement surface and constraining surface facing away from the engagement surface. The latch is supported for movement between an extended position where the constraining surface is disposed in abutment with the catch to limit movement of the coupler relative to the hub and a released position where the latch is spaced from the catch to permit movement of the coupler relative to the hub. The hub has a lock mechanism operatively attached to the latch and being operable between: a first configuration placing the latch in the released position to permit the coupler to disengage from the hub, and a second configuration to permit movement of the latch from the extended position to the released position in response to contact occurring between the housing of the coupler and the engagement surface of the latch.

The present disclosure also provides a system for use in docking an electric vehicle and for charging a battery of the electric vehicle via a power source. The system includes a coupler having a housing adapted for attaching to the electric vehicle, a vehicle power terminal supported by the housing for interfacing with the battery of the electric vehicle, and a catch spaced from the vehicle power terminal. The system also includes a hub having a receiver shaped to engage the housing of the coupler, and a hub power terminal supported by the receiver for interfacing with the power source. The hub power terminal is arranged to abut the vehicle power terminal when the receiver engages the housing of the coupler. The hub also has a latch having an engagement surface and constraining surface facing away from the engagement surface. The latch is supported for movement between an extended position where the constraining surface is disposed in abutment with the catch to limit movement of the coupler relative to the hub and a released position where the latch is spaced from the catch to permit movement of the coupler relative to the hub. The hub has a lock mechanism operatively attached to the latch and being operable between: a first configuration placing the latch in the released position to permit the coupler to disengage from the hub, and a second configuration to permit movement of the latch from the extended position to the released position in response to contact occurring between the housing of the coupler and the engagement surface of the latch. The hub has a biasing element arranged to urge the latch toward the extended position when the lock mechanism operates in the second configuration such that contact occurring between the housing and the engagement surface urges the latch toward the released position as the housing is moved into the receiver, wherein subsequent movement of the housing into the receiver simultaneously brings the vehicle power terminal into electrical contact with the hub power terminal and aligns the catch with the latch to move the latch to the extended position.

The present disclosure further provides a coupler for docking an electric vehicle to a hub for charging a battery of the electric vehicle via a power source, the hub having a receiver, a hub power terminal supported by the receiver, a latch supported by the receiver for movement between an extended position and a released position, and a lock mechanism operatively attached to the latch and being operable between a first configuration and a second configuration to actuate the latch between the extended position and the released position. The coupler includes a housing adapted for attaching to the electric vehicle and shaped to engage the receiver of the hub such that movement of the coupler is limited relative to the receiver when the coupler engages the receiver. A vehicle power terminal is supported by the housing for interfacing with the battery of the electric vehicle, and is arranged to abut the hub power terminal when the housing engages the receiver of the hub. A catch spaced from the vehicle power terminal is configured to receive the latch when the coupler engages the hub. Movement of the housing into the receiver simultaneously brings the vehicle power terminal into electrical contact with the hub power terminal and aligns the catch with the latch to move the latch to the extended position.

Other objects and features of the present disclosure will become apparent when viewed in light of the detailed description when taken in conjunction with the attached drawings and appended claims.

### BRIEF DESCRIPTION OF THE DRAWINGS

In the following figures like reference numerals are used to identify identical components in the various views. The present disclosure will become more fully understood from the detailed description and the accompanying drawings.

FIG. 1A is a perspective view of a system for docking and charging electric vehicles according to embodiments of the present disclosure, shown with four different types of vehicles docked to a hub and with another electric vehicle shown spaced from the hub and having a coupler arranged for engaging the hub.

FIG. 1B is another perspective view of a system of FIG. 1A, shown with five different electric vehicle docket with the hub.

FIG. 2 is a schematic view depicting portions of the system of FIGS. 1A-1B according to embodiments of the present disclosure.

FIG. 3 is a perspective view of the electric vehicle of FIGS. 1A-1B, shown having coupler for docking and charging the electric vehicle according to embodiments of the present disclosure.

FIG. 4 is an enlarged, partial perspective view of the coupler of FIG. 3.

FIG. 5 is a partially-exploded perspective view depicting portions of the coupler of FIG. 3.

FIG. 6 is a perspective view the hub of FIGS. 1A-1B, shown having receivers for docking with and charging electric vehicles according to embodiments of the present disclosure.

FIG. 7 is an enlarged, partial perspective view of the hub of FIG. 6.

FIG. 8 is a partially-exploded view depicting portions of one of the receivers of the hub of FIGS. 6-7.

FIG. 9A is a partial sectional view taken along indicia 9 in FIG. 7, depicting portions of one of the receivers of the hub of FIGS. 6-7 arranged prior to receiving a coupler secured to an electric vehicle.

FIG. 9B is another partial sectional view of the hub of FIG. 9A, depicting portions of the receiver arranged during initial docking with a coupler secured to an electric vehicle.

FIG. 9C is another partial sectional view of the hub of FIG. 9B, depicting portions of the receiver docked with the coupler secured to the electric vehicle.

FIG. 9D is another partial sectional view of the hub of FIG. 9C, depicting a lock mechanism of the receiver released from the coupler secured to the electric vehicle.

### DETAILED DESCRIPTION OF THE EMBODIMENTS

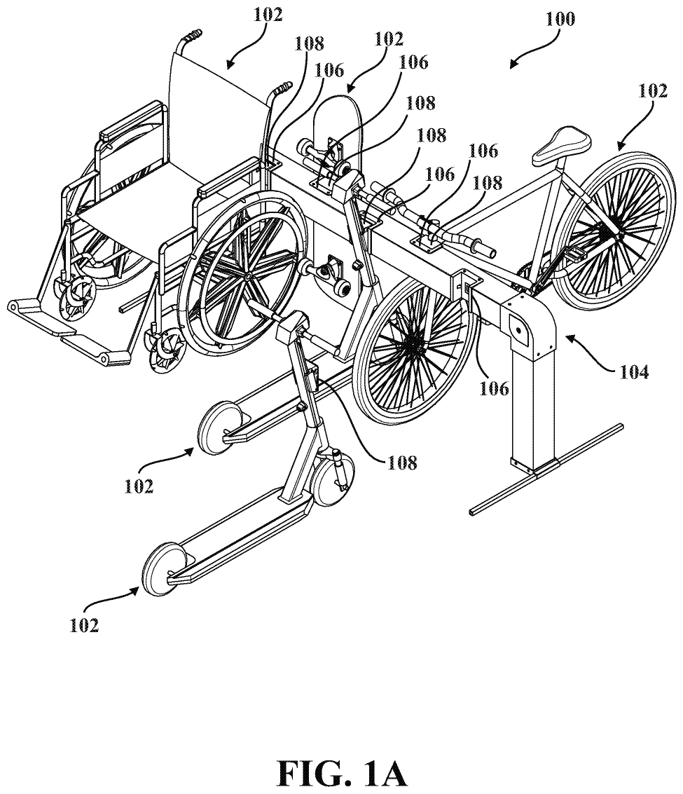

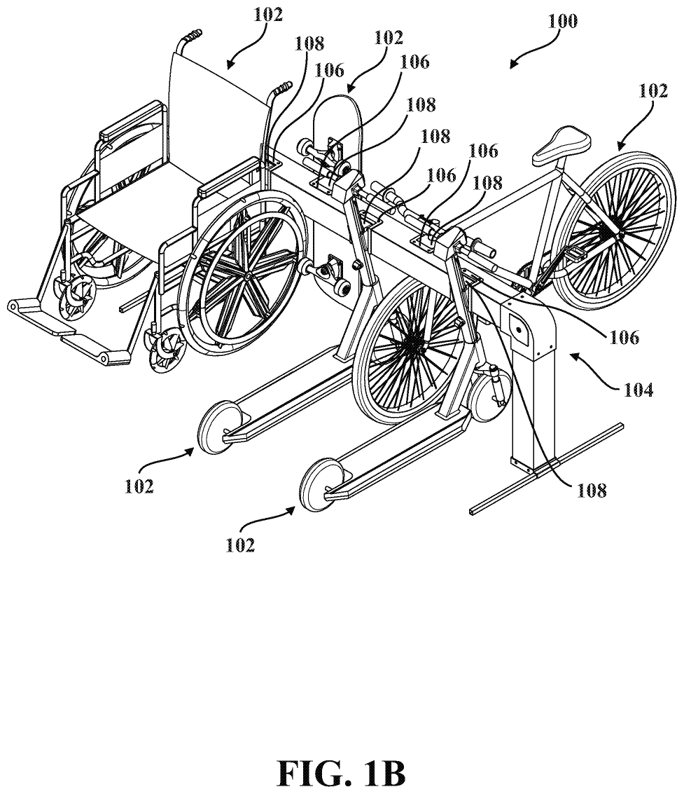

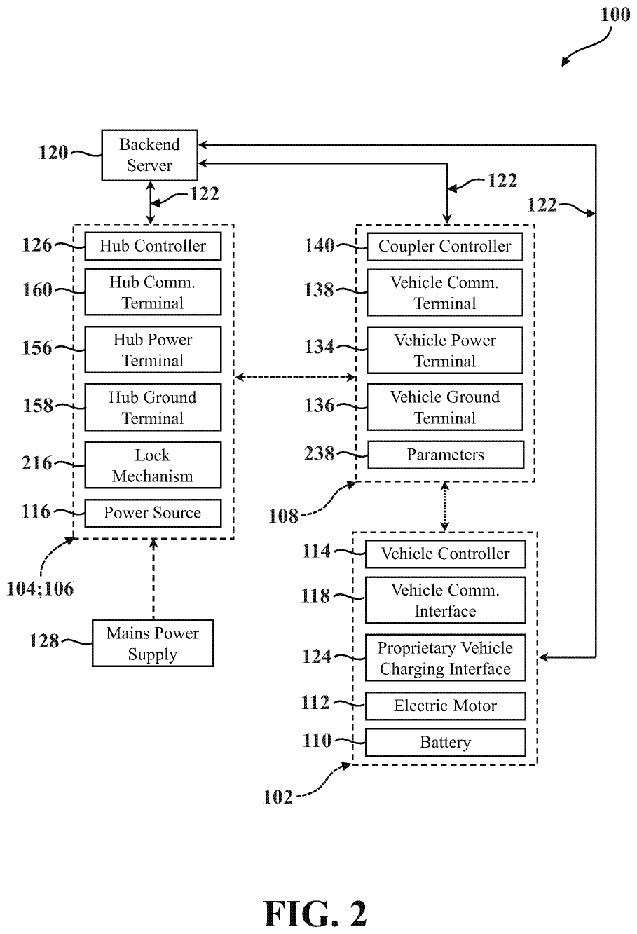

Referring now to FIGS. 1A-2, a system 100 is shown for docking and charging various types of micro-mobility electric vehicle 102 (hereinafter, “electric vehicle”) according to embodiments of the present disclosure. To this end, the system 100 generally includes a hub 104 with one or more receivers 106 that are configured to releasably dock to and retain a coupler 108 secured to a respective electric vehicle 102. The hub 104, receiver 106, and coupler 108 will each be described in greater detail below.

Each electric vehicle 102 comprises a respective battery 110, electric motor 112, and vehicle controller 114 (see FIG. 2: depicted schematically). The battery 110 is configured to be charged via a power source 116 as described in greater detail below, and may be of a number of different styles, types, and/or configurations, realized such as with one or more lithium-ion cells, nickel-metal hydride cells, lead-acid cells, and the like. Depending on the specific configuration of the electric vehicle 102, the battery 110 may be configured to be charged at a particular, predetermined voltage (e.g., at or around 12 volts, 25 volts, 40 volts, 70 volts, or any other suitable voltage) and/or with a particular, predetermined current (e.g., at or around 1 amps, 2 amps, 3 amps, 5 amps, 10 amps, or any other suitable current). The electric vehicle 102 may be a personally owned electric vehicle 102, or a fleet owned electric vehicle 102 such as a ridesharing vehicle available for short-term rental or a municipal vehicle available for public use, operable via one or more types of fleet management systems (not shown, but generally known in the related art).

As will be appreciated from the subsequent description below, the system 100 of the present disclosure is configured to facilitate docking with and charging different types of electric vehicles 102 (e.g., an electric bicycle, an electric scooter, an electric wheelchair, an electric skateboard, and the like), and can facilitate charging different types of batteries 110. In the representative embodiment illustrated in FIGS. 1A-1B, for example, the hub 104 is shown with a total of five separate receivers 106 which are each arranged to dock with a respective coupler 108 secured to a different electric vehicle 102. Here, four different illustrative types of electric vehicles 102 are shown: an electric wheelchair, an electric skateboard, an electric bicycle, and two electric scooters. Thus, the hub 104 of the system 100 is able to facilitate charging batteries 110 of various operating and/or charging characteristics. By way of non-limiting example, the hub 104 may be configured to facilitate charging: an electric wheelchair with a battery 110 having a nominal voltage of around 25 volts, an electric skateboard with a battery 110 having a nominal voltage of around 36 volts, an electric bicycle with a battery 110 having a nominal voltage of around 70 volts, and/or a scooter with a battery 110 having a nominal voltage of around 40 volts. Other configurations are contemplated.

As noted above, the electric vehicles 102 each comprise a respective electric motor 112 configured to generate rotational torque used to drive the electric vehicle 102. Here, it will be appreciated that various arrangements of motors 112, gearboxes, drivetrains, transmissions, wheels, and the like (not shown in detail, but generally known in the related art) may be employed to facilitate propelling electric vehicles 102 powered by batteries 110. The electric motor 112 may be of any suitable type and/or configuration, including without limitation brushed DC motors, brushless DC motors, AC induction motors, and the like.

The vehicle controller 114 is generally employed to facilitate operating the electric motor 112 of the electric vehicle 102 using energy stored in the battery 110 based engagement with a user interface (not shown in detail, but generally known in the related art), such as various arrangements of throttles, levers, buttons, switches, pedals, or other suitable input controls arranged for engagement or activation by a user. Other configurations are contemplated.

As is depicted schematically in FIG. 2, the electric vehicle 102 may comprise a vehicle communication interface 118 that is configured to facilitate wired and/or wireless electrical communication with external or integrated systems, modules, components, and the like. In some embodiments, the vehicle communication interface 118 may be configured for wireless communication with a backend server 120 across a network 122, used such as in connection with fleet vehicle management systems to enable/disable remote control of electric vehicle 102 functionality. Other configurations are contemplated. In some embodiments, the electric vehicle 102 may comprise a proprietary vehicle charging interface 124 (e.g., a “charging port”) disposed in electrical communication with the battery 110 and/or the vehicle controller 114 to facilitate “wired” charging of the battery 110 (e.g., via an AC to DC charging adapter).

The vehicle controller 114 may be any suitable computing device configurable to control the electric vehicle's 102 electric motor 112 and control any additional functionality of the electric vehicle 102. The vehicle controller 114 may be realized as a computer with one or more processors (e.g., a central processing unit), memory, and/or storage (not shown), and may generally loaded with software, firmware, and the like. The vehicle controller 114 may utilize any suitable type of microprocessor, multi-processor, and/or multi-core processing system. Additionally or alternatively, the vehicle controller 114 may comprise one or more microcontrollers, field programmable gate arrays, systems on a chip, discrete circuitry, and/or other suitable hardware, software, and/or firmware.

With continued reference to FIGS. 1A-2, as noted above, the receiver 106 of the hub 104 is configured to dock with couplers 108 secured to electric vehicles 102 to, among other things, facilitate charging batteries 110 of docked electric vehicles 102 using the power source 116. In some embodiments, the power source 116 may be realized with one or more AC to DC converters that are configured to provide charging power to the battery 110 at a fixed or variable voltage and/or at a fixed or variable current. In some embodiments, the system 100 may include one or more hub controllers 126 configured to regulate or otherwise adjust electrical voltage and/or current from power source 116 so as to accommodate specific charging parameters of a docked electric vehicle 102, as described in greater detail below. Thus, the hub controller 126 may define or otherwise control the power source 116 in some embodiments. The hub controller 126 may be realized as a computer with one or more processors (e.g., a central processing unit), memory, and/or storage (not shown), and may generally loaded with software, firmware, and the like. The hub controller 126 may utilize any suitable type of microprocessor, multi-processor, and/or multi-core processing system. Additionally or alternatively, the hub controller 126 may comprise one or more microcontrollers, field programmable gate arrays, systems on a chip, discrete circuitry, and/or other suitable hardware, software, and/or firmware. Other configurations are contemplated.

In some embodiments, a mains power supply 128 (e.g., AC power supplied at 120 volts, 240 volts, and the like) may be used to facilitate operating the hub controller 126 in some embodiments. In some embodiments, the mains power supply 128 could be used to provide power to respective power sources 116 of each receiver 106 of the hub 104 that are controlled via the hub controller 126 (e.g., realized with one or more fixed or adjustable AC to DC converters). Other configurations are contemplated, and it will be appreciated that the mains power supply 128 could be realized in a number of different ways, including without limitation as a conventional AC outlet, a DC power supply, an auxiliary battery, a solar panel array, a fuel cell, a generator, and the like.

As noted above, the embodiments of the system 100 of the present disclosure are configured for use in docking electric vehicles 102 and for charging the batteries 110 of electric vehicles 102 via the power source 116 via engagement occurring between the receiver 106 of the hub 104 and the coupler 108 secured to the electric vehicle 102. To this end, and as is best depicted in FIGS. 2-5, the coupler 108 generally includes a housing 130 adapted for attaching to the electric vehicle 102, a catch 132, and a vehicle power terminal 134 that is spaced from the catch 132 and supported by the housing 130 for interfacing with the battery 110 of the electric vehicle 102, such as via electrical communication with a positive voltage lead of the battery 110, to a portion of the proprietary vehicle charging interface 124, and the like. In some embodiments, the coupler 108 may also include a vehicle ground terminal 136 supported by the housing 130 for interfacing with the battery 110 of the electric vehicle 102, such as via electrical communication with a negative voltage lead of the battery 110, to a portion of the proprietary vehicle charging interface 124, and the like. In some embodiments, the coupler 108 may also include a vehicle communication terminal 138 supported by the housing 130 for interfacing with the electric vehicle 102, such as via electrical communication with a coupler controller 140 (depicted schematically), a portion of the proprietary vehicle charging interface 124, and the like.

The coupler controller 140 may be configured to facilitate wired and/or wireless electrical communication between one or more components of the electric vehicle 102 and one or more portions of the coupler 108, including without limitation communication between and/or across one or more of: the vehicle terminals 134, 136, 138, the battery 110, the proprietary vehicle charging interface 124, the vehicle controller 114, the backend server 120 (e.g., across the network 122). The coupler controller 140 may be realized as a computer with one or more processors (e.g., a central processing unit), memory, and/or storage (not shown), and may generally loaded with software, firmware, and the like. The coupler controller 140 may utilize any suitable type of microprocessor, multi-processor, and/or multi-core processing system. Additionally or alternatively, the coupler controller 140 may comprise one or more microcontrollers, field programmable gate arrays, systems on a chip, discrete circuitry, and/or other suitable hardware, software, and/or firmware. Other configurations are contemplated.

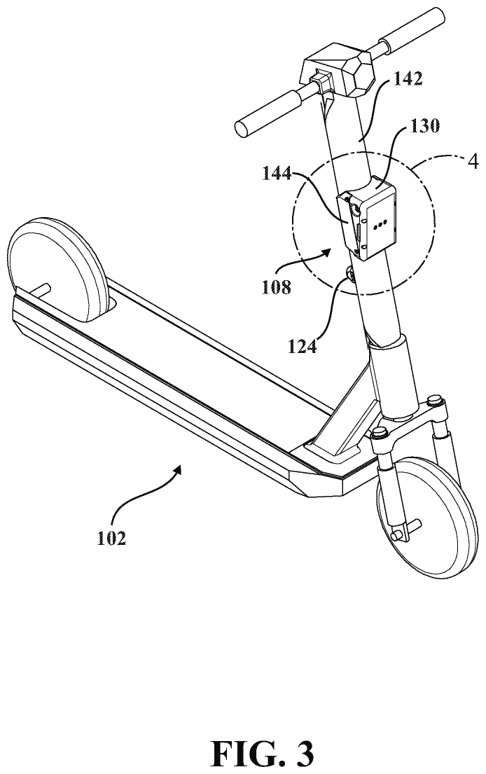

As is best shown in FIGS. 1A and 3-4, the housing 130 of the coupler 108 may be attached or otherwise secured to the electric vehicle 102 in various ways depending on the specific configuration of the electric vehicle 102. In the embodiment illustrated in FIGS. 3-5, for example, the electric vehicle 102 is realized as an electric scooter which has an elongated steering column 142 with a generally D-shaped profile, and the coupler 108 is configured to be removably attached to the elongated steering column 142. To this end, in some embodiments, the coupler 108 may include one or more brackets 144 configured to secure to the housing 130 via fasteners (not shown), by interlocking mechanical features, or by other suitable attachment methodologies. In some embodiments, one or more portions of the coupler 108 may be integrated into the electric vehicle 102 during manufacture of the electric vehicle 102. However, it is also contemplated that that couplers 108 may be secured to pre-manufactured electric vehicles 102 as an “aftermarket” option, accessory, module, and the like.

As will be appreciated from the subsequent description of the receiver 106 of the hub 104 below, in the representative embodiment illustrated herein, the housing 130 of the coupler 108 defines an outer profile 146 which corresponds to the profile of a void 148 defined by the receiver 106 of the hub 104. Here, the outer profile 146 of the housing 130 defines a front surface 150, a first lateral surface 152 extending from the front surface 150, and a second lateral surface 154 extending from the front surface 150 and spaced from the first lateral surface 152. In the representative embodiment illustrated herein, the first lateral surface 152 and the second lateral surface 154 are arranged substantially perpendicular to the front surface 150, and are arranged substantially parallel to each other. However, other configurations are contemplated. The housing 130 may define a particular aspect ratio that is complimentary to the void 148 of the receiver 106 to ensure that the coupler 108 remains securely docked with the receiver 106.

As noted above, the illustrative embodiment of the coupler 108 includes vehicle terminals 134, 136, 138 disposed in communication with one or more portions of the electric vehicle 102 (e.g., the battery 110, the vehicle controller 114, the vehicle interfaces 118, 124, and the like) and/or the coupler 108 itself (e.g., the coupler controller 140). As will be appreciated from the subsequent description below, the vehicle terminals 134, 136, 138 are arranged to engage against corresponding hub terminals 156, 158, 160 of the receiver 106 to facilitate electrical communication between the hub 104 and the electric vehicle 102 docked thereto. Here, for example, the receiver 106 of the hub 104 may include a hub power terminal 156, as well as a hub ground terminal 158 and/or a hub communication terminal 160. Other configurations are contemplated.

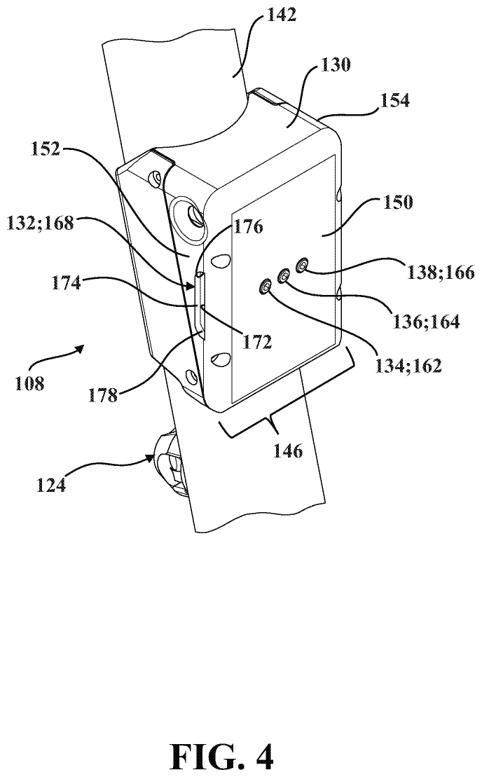

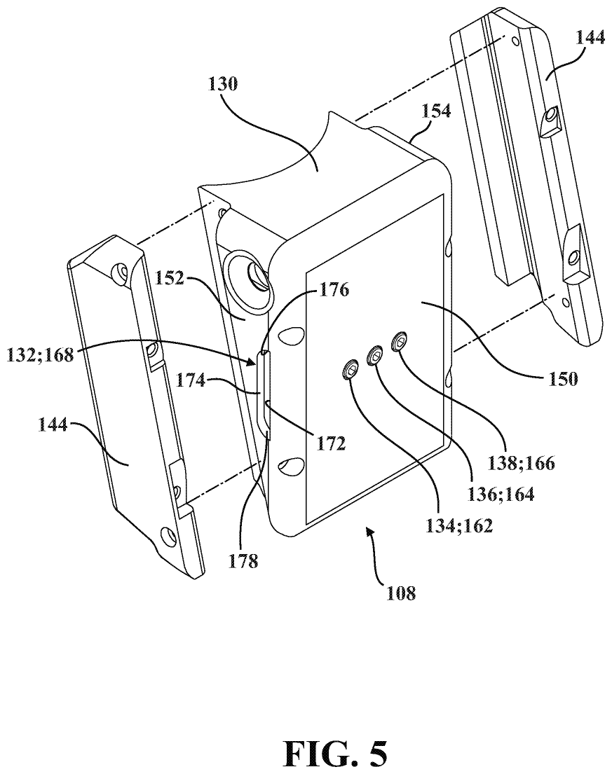

In some embodiments, the vehicle power terminal 134 may be realized as a power pin 162 in electrical communication with the battery 110 of the electrical vehicle 102 such that the battery 110 of the electric vehicle 102 can be charged with the power pin being energized via the power source 116 when the coupler 108 is docked to the receiver 106. In some embodiments, the vehicle ground terminal 136 may be realized as a ground pin 164 in electrical communication with the battery 110 and/or another portion of the electrical vehicle 102 to electrically ground the electric vehicle 102 to the hub 104 when the coupler 108 is docked to the receiver 106. In some embodiments, the vehicle communication terminal 138 may be realized as a communication pin 166 in communication with the vehicle controller 114 to transmit data, signals, and the like between the hub 104 (e.g., the hub controller 126) and one or more of the electric vehicle 102 (e.g., the vehicle controller 114) and the coupler 108 (e.g., the coupler controller 140). In some embodiments, the pins 162, 164, 166 may be realized as “pogo pins” that are spring-biased outward from the front surface 150 of the housing 130. However, it will be appreciated that other configurations are contemplated, such as plug-and-socket connectors, blade connectors, and the like. The vehicle power terminal 134, the vehicle ground terminal 136, and the vehicle communication terminal 138 may be arranged in a spaced relationship about the housing 130. For example, in the illustrative embodiment depicted in FIGS. 4-5, the vehicle power terminal 134, the vehicle ground terminal 136, and the vehicle communication terminal 138 are arranged such that they are linearly spaced about the front surface 150 of the housing 130. However, it will be appreciated that other arrangements about the housing 130 are contemplated.

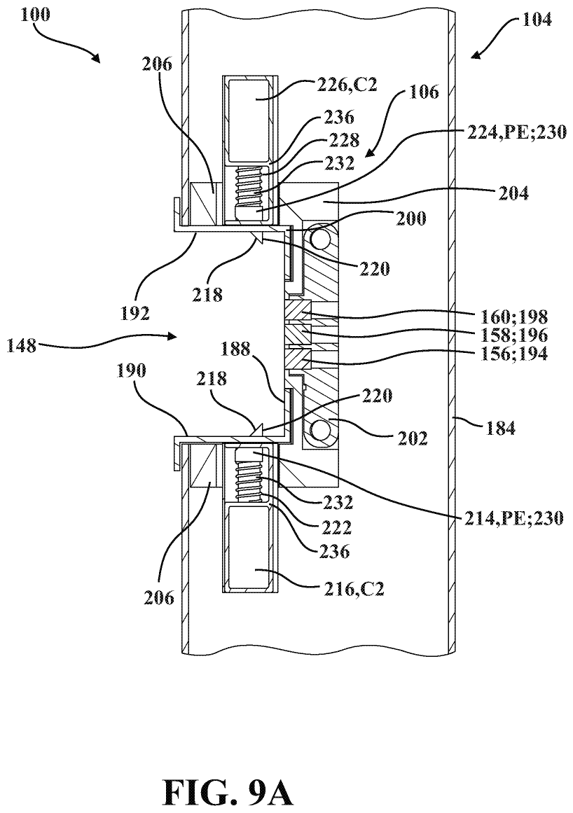

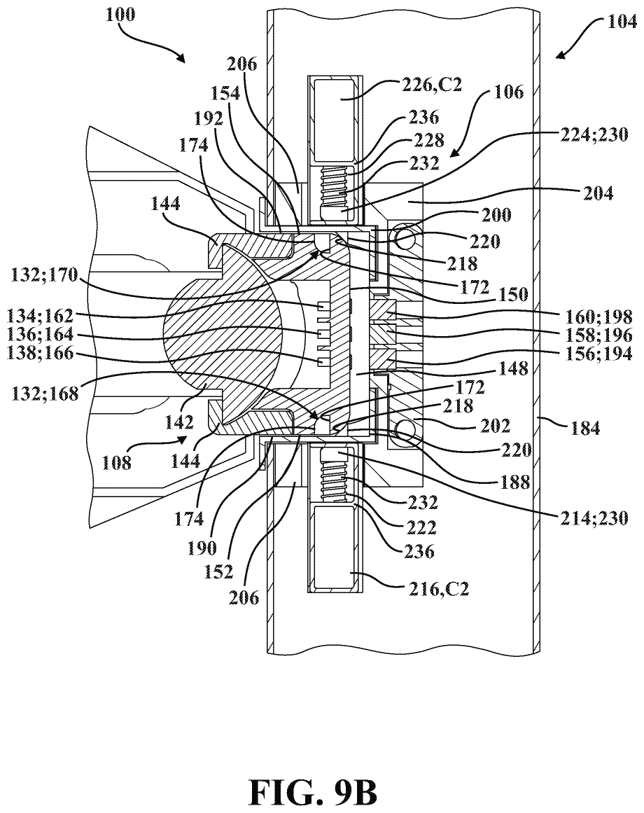

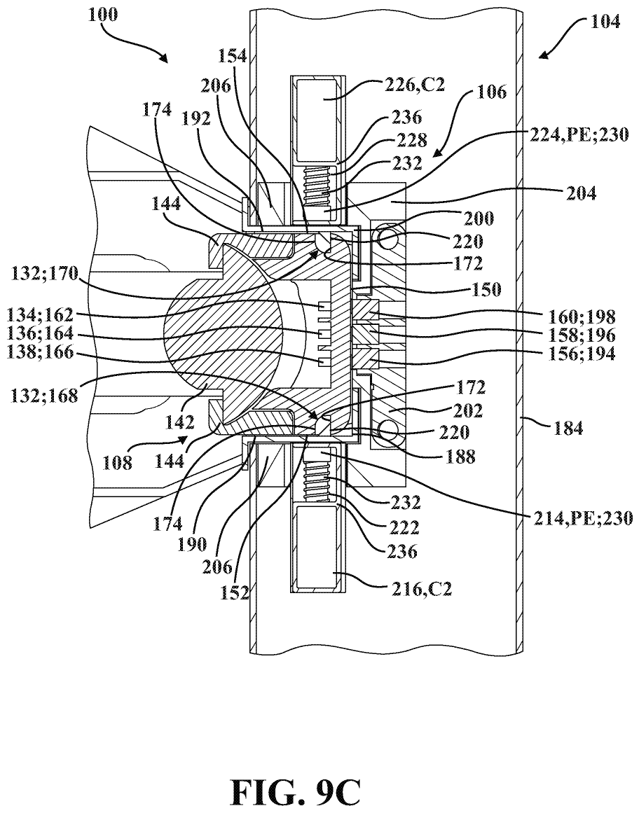

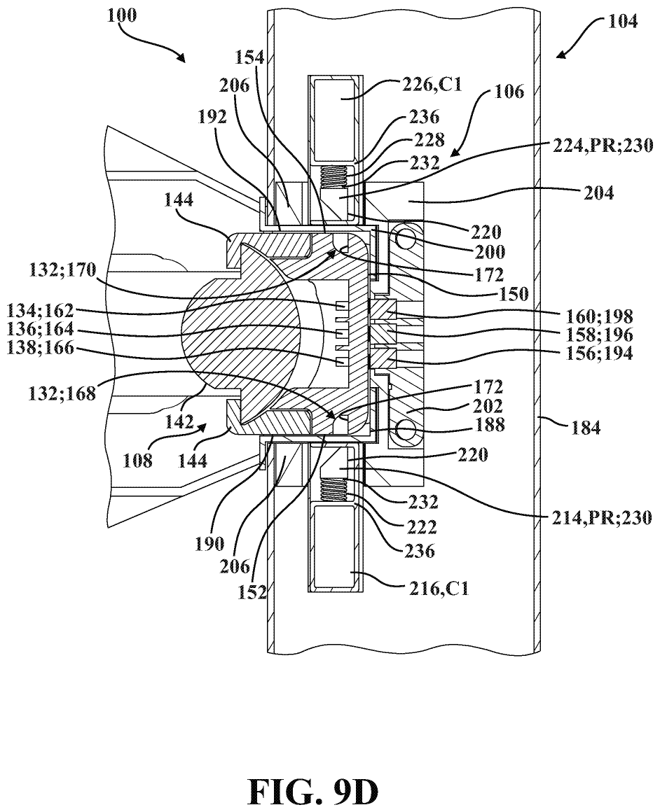

As noted above, the coupler 108 includes the catch 132 spaced from the vehicle power terminal 134, which is used to facilitate docking with the receiver 106 of the hub 104 as described in greater detail below in connection with FIGS. 9A-9D. In some embodiments, the catch 132 may include a first notch 168 formed in the first lateral surface 152 of the housing 130. In the representative embodiment illustrated herein, the catch 132 includes both the first notch 168, as well as a second notch 170 formed in the second lateral surface 154 of the housing 130. As is best shown in FIGS. 3-5 (see also FIG. 9B), each of the notches 168, 170 include a respective front retention surface 172, a rear retention surface 174 spaced from the front retention surface 172, a top retention surface 176 extending between the front retention surface 172 and the rear retention surface 174, and a bottom retention surface 178 extending between the front retention surface 172 and the rear retention surface 174 and spaced from the top retention surface 176. It is contemplated that the catch 132 may include any suitable number of notches 168, 170, arranged in various ways (e.g., formed in or otherwise defined by other surfaces of the housing 130, other components of the coupler 108, and the like). By way of non-limiting example, the catch 132 may be disposed on a different surface than the vehicle power terminal 134. Other configurations are contemplated.

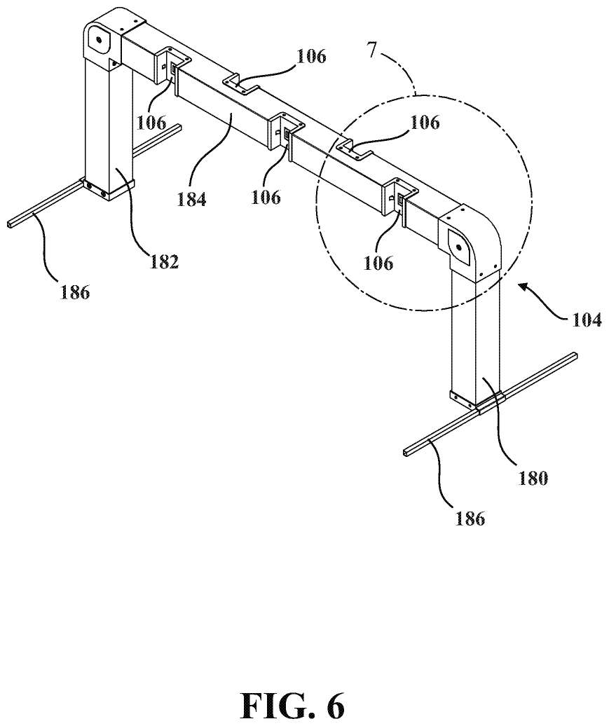

Referring now to FIGS. 1A-1B and 6-8, as noted above, the hub 104 may be configured with one or more receivers 106 shaped and arranged to facilitate docking with couplers 108 of different electric vehicles 102. The representative embodiment of the hub 104 illustrated herein employs a total of five receivers 106, but other quantities and/or arrangements of receivers 106 are contemplated by the present disclosure. The hub 104 includes a first vertical post 180, a second vertical post 182, and a rail 184 extending between the first vertical post 180 and the second vertical post 182. The first vertical post 180 and the second vertical post 182 may be supported by feet 186, or may be anchored or otherwise secured to the ground. The rail 184 may be configured to support one or more receivers 106, as noted above. While the rail 184 depicted throughout the drawings has a substantially linear, elongated profile, other configurations are contemplated, and other types of rails 184 with different profiles, layouts, and the like may be utilized. By way of non-limiting example, rails 184 could be curved, arranged in grids, and the like. The rail 184 of the hub 104 may support a plurality of receivers 106 that are staggered on both sides of the rail 184, such as shown FIG. 6, but it is also contemplated to have receivers 106 supported only on one side of the rail 184. Advantageously, the rail 184 and the receivers 106 may be positioned such that the hub 104 is capable of storing a variety docked electric vehicles 102, of the same type or of differing types, in an orderly fashion so as to help eliminate clutter that is commonplace with conventional micro-mobility electric vehicle 102 charging stations.

The receiver 106 of the hub 104 is shaped to engage the housing 130 of the coupler 108, and defines a void 148 that is complimentary to the shape of the housing 130. More specifically, in some embodiments, the void 148 has (or is otherwise defined by) a rear surface 188, a first side surface 190 extending from the rear surface 188, and a second side surface 192 extending from the rear surface 188 and spaced from the first side surface 190. The first side surface 190 and the second side surface 192 may be substantially perpendicular to the rear surface 188 and substantially parallel to each other. Here, the void 148 defines a generally rectangular C-shaped profile which corresponds to the outer profile 146 of the housing 130 of the coupler 108 such that the coupler 108 may engage the receiver 106.

Similar to the housing 130 of the coupler 108, the receiver 106 may define a particular aspect ratio. For example, the rear surface 188 of the receiver 106 may be taller than it is wide such that rotation of the housing 130 of the coupler 108 is limited when the housing 130 engages the receiver 106. Additionally, for example, referring to FIGS. 1A-1B, and FIGS. 9A-9D, the front surface 150 of the housing 130 may be aligned with the rear surface 188 of the receiver 106, the first lateral surface 152 of the housing 130 may be aligned with the first side surface 190 of the receiver 106, and the second lateral surface 154 of the housing 130 may be aligned with the second side surface 192 of the receiver 106 such that movement of the coupler 108 relative to the receiver 106 of the hub 104 is limited when the housing 130 is engaged with the receiver 106. More specifically, the clearance between the aforementioned surfaces may be limited such that the housing 130 has little room to rotate or translate relative to the receiver 106 when the housing 130 is engaged with the receiver 106. Further, the clearance between the aforementioned surfaces may be limited such that the receiver 106 of the hub 104 provides the coupler 108 shielding from environmental elements (such as rain or snow) when the housing 130 is engaged with the coupler 108. Other configurations are contemplated.

As is best shown in FIGS. 6-8, the hub power terminal 156 is supported by the receiver 106 for interfacing with the power source 116 (see also FIG. 2; depicted schematically), and is arranged to abut the vehicle power terminal 134 when the receiver 106 engages the housing 130 of the coupler 108, as described in greater detail below in connection with FIGS. 9A-9D. In some embodiments, the hub power terminal 156 may be realized as a power contact plate 194 configured to contact the power pin 162 of the coupler 108 to energize the power pin 162 and charge the battery 110 of the electric vehicle 102.

In some embodiments, the hub 104 employs the hub ground terminal 158 to facilitate charging the battery 110 or otherwise grounding the electric vehicle 102. The hub ground terminal 158 is supported by the receiver 106 and is arranged to abut the vehicle ground terminal 136 when the receiver 106 engages the housing 130 of the coupler 108. In some embodiments, the hub ground terminal 158 may be realized as a ground contact plate 196 configured to contact the ground pin 164 of the coupler 108 to facilitate charging the battery 110 or otherwise electrically grounding the electric vehicle 102 when the housing 130 engages the hub 104.

In some embodiments, the hub 104 employs the hub communication terminal 160 to facilitate communication between the hub 104 and the electric vehicle 102 and/or the coupler 108. The hub communication terminal 160 is supported by the receiver 106 and is arranged to abut the vehicle communication terminal 138 when the receiver 106 engages the housing 130 of the coupler 108. In some embodiments, the hub communication terminal 160 may be realized as a communication contact plate 198 configured to contact the communication pin 166 of the coupler 108 to transmit data, signals, and the like.

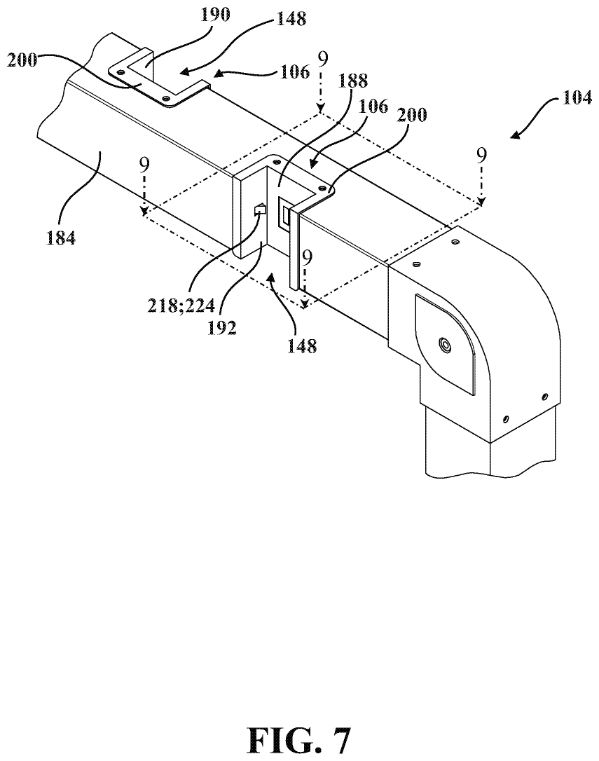

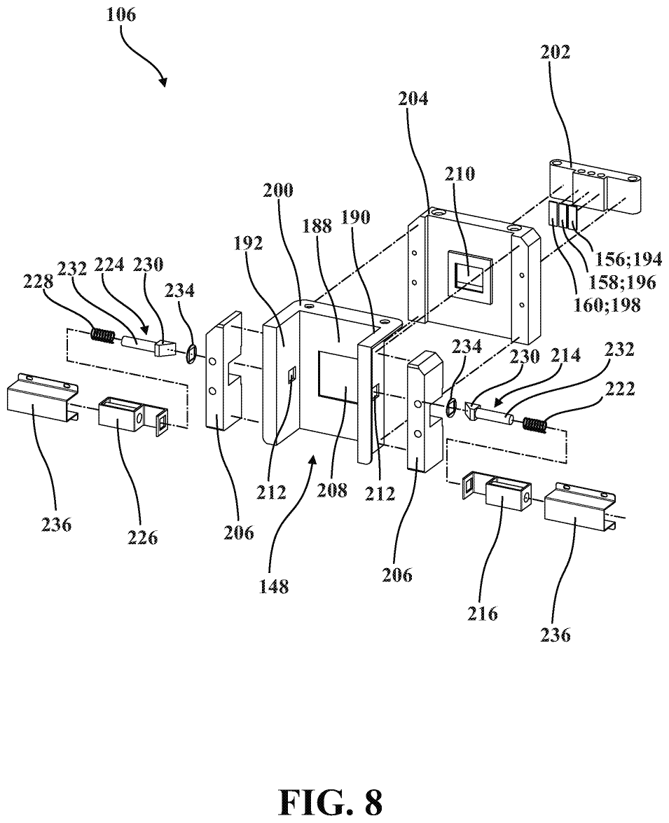

Similar to the configuration of the vehicle terminals on the coupler 108, the hub power terminal 156, the hub ground terminal 158, and the hub communication terminal 160 may be arranged in a spaced relationship about the receiver 106. For example, referring to FIGS. 7-8, the hub power terminal 156, the hub ground terminal 158, and the hub communication terminal 160 are arranged such that they are linearly spaced apart about the rear surface 188 of the receiver 106. However, other arrangements are contemplated, and the hub terminals 156, 158, 160 could be supported along or adjacent to other surfaces of the receiver 106. In some embodiments, the ground contact plate 196 or the ground pin 164 may be arranged such that the ground pin 164 abuts the ground contact plate 196 before the power pin 162 contact the power contact plate 194, and/or before the communication pin 166 contacts the communication contact plate 198. Other configurations are contemplated.

Referring to FIGS. 8 and 9A-9D, the illustrated embodiment of the receiver 106 includes a receiver frame 200 to which a plate frame 202, a shield 204, and spacer blocks 206 are operatively attached, such as with fasteners (not shown). The receiver frame 200 is configured to be attached to the rail 184 of the hub 104, such as with fasteners (not shown), and generally supports the components attached thereto. The receiver frame 200 defines a plate aperture 208 extending therethrough to accommodate the contact plates 194, 196, 198 (which define the hub terminals 156, 158, 160 in the illustrated embodiment). The plate frame 202 supports the contact plates 194, 196, 198, and may be wired to or otherwise disposed in electrical communication with other parts of the hub 104, such as the power source 116, the hub controller 126, and the like. Which shown as a separate component in the illustrated embodiment, the plate frame 202 may be formed integrally with the receiver frame 200 or other components of the receiver 106.

The shield 204 is operatively attached to the receiver frame 200 as noted above, and includes a shield aperture 210 defined extending therethrough to accommodate the contact plates 194, 196, 198 (which define the hub terminals 156, 158, 160 in the illustrated embodiment). The shield 204 also generally defines the rear surface 188, the first side surface 190, and the second side surface 192 in the illustrated embodiment. The shield 204 also includes a latch aperture 212 formed extending through each of the first and second side surfaces 190, 192 adjacent to where the spacer blocks 206 are disposed.

Referring now to FIGS. 8-9D, a latch 214 and a lock mechanism 216 are shown for facilitating docking the housing 130 of the coupler 108 to the receiver 106 of the hub 104. The latch 214 comprises an engagement surface 218 and a constraining surface 220 facing away from the engagement surface 218. The latch 214 is supported for movement between an extended position PE (see FIGS. 9A and 9C), a released position PR (see FIG. 9D), and to positions between the extended position PE and the released position PR (see FIG. 9B). As is best depicted in FIG. 9C, the constraining surface 220 of the latch 214 is disposed in abutment with the catch 132 (more specifically, with the front retention surface 172) when the coupler 108 is docked to the hub 104 to limit movement of the coupler 108 relative to the hub 104. When in the released position PR as depicted in FIG. 9D, the latch 214 is spaced from the catch 132 (more specifically, with the constraining surface 220 out of abutment with the front retention surface 172) to permit movement of the coupler 108 relative to the hub 104.

The lock mechanism 216 is operatively attached to the latch 214 and is operable between a first configuration C1 (see FIG. 9D) and a second configuration C2 (see FIGS. 9A-9C). When operating in the first configuration C1, the lock mechanism 216 places the latch 214 in the released position PR to permit the coupler 108 to disengage from the hub 104. When operating in the second configuration C2, the lock mechanism 216 permits movement of the latch 214 from the extended position PE to the released position PR in response to contact occurring between the housing 130 of the coupler 108 and the engagement surface 218 of the latch 214 (see FIG. 9B). Here, a biasing element 222 is arranged to urge the latch 214 toward the extended position PE when the lock mechanism 216 operates in the second configuration C2 such that contact occurring between the housing 130 and the engagement surface 218 urges the latch 214 toward the released position PR as the housing 130 is moved into the receiver 106 (successively compare FIGS. 9A and 9B). Here, subsequent movement of the housing 130 into the receiver 106 simultaneously brings the vehicle power terminal 134 into electrical contact with the hub power terminal 156 (as well as bringing the other vehicle terminals 136, 138 into electrical contact with the other hub terminals 158, 160) and aligns the catch 132 with the latch 214 to move the latch 214 to the extended position PE (successively compare FIGS. 9B and 9C). It will be appreciated that this configuration locks the coupler 108 to the receiver 106 of the hub 104 while, at the same time, facilitating electrical communication between the hub 104 and the electric vehicle 102 so as to charge the battery 110 with the power source 116.

In other words, when the lock mechanism 216 is in the second configuration C2, the biasing element 222 urges the latch 214 toward the extended position PE. Thus, as illustrated sequentially in FIGS. 9A-9D, as the housing 130 of the coupler 108 engages the receiver 106 of the hub 104, the latch 214 is displaced toward the released position PR such that the housing 130 can fully engage the receiver 106. FIG. 9A shows the receiver 106 of the hub 104 with no coupler 108 engaged thereto. FIG. 9B shows the coupler 108 beginning to engage the receiver 106. Here, when the housing 130 begins to engage the receiver 106, the front surface 150 and/or the lateral surfaces 152, 154 of the housing 130 may abut the engagement surface 218 of the latch 214 such that the latch 214 is displaced away from the extended position PE as the housing 130 engages the receiver 106. Then, as illustrated in FIG. 9C, once the latch 214 is aligned with the catch 132, the biasing element 222 urges the latch 214 back toward the extended position PE inside the catch 132.

It will be appreciated that this configurations allows the latch 214 to automatically engage the catch 132 to mechanically dock the housing 130 of the coupler 108 to the receiver 106 of the hub 104 while the lock mechanism 216 operates in the second configuration C2, without necessitating that the lock mechanism 216 be driven, controlled, or otherwise actuated during the initial process of docking the coupler 108 to the hub 104. Thus, the electric vehicle 102 is immediately locked to the hub 104 as soon as the coupler 108 engages the hub 104, and can only be released from the hub 104 when the lock mechanism 216 is subsequently operated in the first configuration C1 to move the latch 214 to the released position PR. Here, when a user/owner desires to remove the electric vehicle 102 from the hub 104, the lock mechanism 216 can then be operated in the first configuration C1 (e.g., via the hub controller 126) to move the latch 214 to the released position PR (see FIG. 9D).

In the representative embodiment illustrated herein, the latch 214 engages the first notch 168 of the catch 132; and a second latch 224 driven by a second lock mechanism 226 and biased by a second biasing element 228, are utilized to facilitate engagement with the second notch 170 of the catch 132. However, it will be appreciated that other arrangements are contemplated.

In some embodiments, the latch 214 is coupled to the receiver 106 adjacent to the first side surface 190 such that its constraining surface 220 extends at least partially into the first notch 168 when the latch 214 is in the extended position PE to limit movement of the coupler 108 relative to the receiver 106 (see FIG. 9C). Here, the constraining surface 220 abuts the front retention surface 172 of the first notch 168 when the coupler 108 engages the receiver 106 when the latch 214 is in the extended position PE. Similarly, in some embodiments, the second latch 224 is coupled to the receiver 106 adjacent to the second side surface 192 such that its constraining surface 220 extends at least partially into the second notch 170 when the second latch 224 is in the extended position PE to limit movement of the coupler 108 relative to the receiver 106 (see FIG. 9C). Here, the constraining surface 220 abuts the front retention surface 172 of the second notch 170 when the coupler 108 engages the receiver 106 when the latch 214 is in the extended position PE.

As is best shown in FIG. 8, the engagement and constraining surfaces 218, 220 of each of the latches 214, 224 are defined by respective latch heads 230 which, in turn, extend from respective latch shanks 232, and pass through the latch apertures 212 formed in the shield 204. The biasing elements 222, 228 are disposed about the latch shanks 232, and are retained along with the latches 214, 224 via respective keepers 234 configured to prevent the latches 214, 224 from moving beyond their respective extended positions PE. Here, respective lock brackets 236 facilitate securing the lock mechanisms 216, 226 to the spacer blocks 206, such as with fasteners (not shown), or to other components of the receiver 106. Other configurations are contemplated.

In the representative embodiment illustrated herein, the lock mechanisms 216, 226 are each realized as solenoids with coils (not shown in detail) arranged about the latch shanks 232 to facilitate movement of the latches 214, 224 to the respective released positions PR. In some embodiments, operation in the first configuration C1 is effected by energizing the lock mechanisms 216, 226 (e.g., by applying power to the coils), and operation in the second configuration C2 is effected by not applying energy to the lock mechanisms 216, 226 (e.g., by not applying power to the coils). In some embodiments, power, signals, and the like may be provided to the lock mechanism 216, 226 via the hub controller 126 in order to control operation between the first and second configurations C1, C2. It will be appreciated that the lock mechanisms 216, 226 could be driven or otherwise actuated in a number of different ways, using such as other types of electromechanical actuators, hydraulic actuators, pneumatic actuators, and the like.

As noted above, movement of the housing 130 into the receiver 106 simultaneously brings the vehicle power terminal 134 into electrical contact with the hub power terminal 156. In some embodiments, this movement also brings the vehicle ground terminal 136 into electrical contact with the hub ground terminal 158, and/or brings the vehicle communication terminal 138 into electrical contact with the hub communication terminal 160. In some embodiments, and as is depicted schematically in FIG. 2, the hub controller 126 may be configured to detect parameters 238 associated with the docked electric vehicle 102 across the electrical connection established between the vehicle communication terminal 138 and the hub communication terminal 160 when the housing 130 of the coupler 108 engages the receiver 106 of the hub. Here, the hub controller 126 may be configured to direct power from the power source 116 across the electrical connection established between the vehicle power terminal 134 and the hub power terminal 156, as well as across the electrical connection established between the vehicle ground terminal 136 and the hub ground terminal 158, in response to detecting the parameters 238.

In some embodiments, the coupler controller 140 is configured to store the parameters 238 (e.g., such as on memory; not shown), and to transmit the parameters 238 associated with the electric vehicle 102 via the vehicle communication terminal 138 across the hub communication terminal 160 to the hub controller 126 when the housing 130 of the coupler 108 engages (e.g., becomes docked to) the receiver 106 of the hub 104. Here, the parameters 238 may include identifying information about the electric vehicle 102 (e.g., type, make, model, brand, serial number, identification number, fleet identification number, and the like), information about the battery 110 onboard of the electric vehicle 102 (e.g., battery type, size, type, layout, target charging voltage, target charging current, nominal voltage, current charge, charge cycles, remaining life, and the like), and/or information concerning the ownership and/or utilization of the electric vehicle 102 (e.g., contact information or identifying information about the user or owner, and the like). It will be appreciated that the parameters 238 may be exchanged between one or more of the hub controller 126, the coupler controller 140, the vehicle controller 114, and/or the backend server 120 using any suitable communication protocol, signal type, and the like.

In some embodiments, the hub controller 126 may be configured to direct a certain voltage and/or current to the battery 110 of the electric vehicle 102 via the power source 116 based on the parameters 238 received from the coupler controller 140 (and/or the vehicle controller 114) that are associated with the electric vehicle 102. Thus, the hub 104 is capable of charging a variety of different electric vehicle 102 architectures, types, and the like, and is capable of adjusting the voltage and/or current of the power being directed from the power source 116 through the hub power terminal 156 to the vehicle power terminal 134 and ultimately to the battery 110. It will be appreciated that the ability to charge a variety of electric vehicles 102 provides the advantage of accepting a wide range of electric vehicle 102 types/brands such that the system 100 is not limited to only one certain type/brand of vehicle, allowing for broader adoption in the market.

Several configurations have been discussed in the foregoing description. However, the configurations discussed herein are not intended to be exhaustive or limit the invention to any particular form. The terminology which has been used is intended to be in the nature of words of description rather than of limitation. Many modifications and variations are possible in light of the above teachings and the invention may be practiced otherwise than as specifically described.

1. A system for use in docking an electric vehicle and for charging a battery of the electric vehicle via a power source, said system comprising:
a coupler comprising a housing adapted for attaching to the electric vehicle, a vehicle power terminal supported by said housing for interfacing with the battery of the electric vehicle, and a catch spaced from said vehicle power terminal; and
a hub comprising:
a receiver shaped to engage said housing of said coupler,
a hub power terminal supported by said receiver for interfacing with the power source and arranged to abut said vehicle power terminal when said receiver engages said housing of said coupler,
a latch comprising an engagement surface and a constraining surface facing away from said engagement surface, said latch being supported for movement between: an extended position where said constraining surface is disposed in abutment with said catch to limit movement of said coupler relative to said hub; and a released position where said latch is spaced from said catch to permit movement of said coupler relative to said hub, and
a lock mechanism operatively attached to said latch and being operable between: a first configuration placing said latch in said released position to permit said coupler to disengage from said hub; and a second configuration to permit movement of said latch from said extended position to said released position in response to contact occurring between said housing of said coupler and said engagement surface of said latch.

2. The system of claim 1, wherein said hub further includes a biasing element arranged to urge said latch toward said extended position when said lock mechanism operates in said second configuration such that contact occurring between said housing and said engagement surface urges the latch toward said released position as said housing is moved into said receiver, and wherein subsequent movement of said housing into said receiver simultaneously brings said vehicle power terminal into electrical contact with said hub power terminal and aligns said catch with said latch to move said latch to said extended position.

3. The system of claim 1, wherein said receiver of said hub defines a void having a rear surface, a first side surface extending from said rear surface, and a second side surface extending from said rear surface and spaced from said first side surface.

4. The system of claim 3, wherein said first side surface and said second side surface are arranged substantially perpendicular to said rear surface; and
wherein said first side surface and said second side surface are arranged substantially parallel to each other.

5. The system of claim 3, wherein said housing of said coupler defines an outer profile corresponding to said void of said receiver, said housing having a front surface, a first lateral surface extending from said front surface, and a second lateral surface extending from said front surface and spaced from said first lateral surface.

6. The system of claim 5, wherein said first lateral surface and said second lateral surface are arranged substantially perpendicular to said front surface; and
wherein said first lateral surface and said second lateral surface are arranged substantially parallel to each other.

7. The system of claim 5, wherein said catch includes a first notch formed in said first lateral surface of said housing.

8. The system of claim 7, wherein said latch is coupled to said receiver adjacent to said first side surface such that said constraining surface extends at least partially into said first notch when said latch is in said extended position to limit movement of said coupler relative to said receiver.

9. The system of claim 7, wherein said first notch defines a front retention surface, a rear retention surface spaced from said front retention surface, a top retention surface extending between said front retention surface and said rear retention surface, and a bottom retention surface extending between said front retention surface and said rear retention surface and spaced from said top retention surface; and
wherein said constraining surface abuts said front retention surface when said coupler engages said receiver to limit movement of said coupler to said receiver when said latch is in said extended position.

10. (canceled)

11. The system of claim 7, wherein said catch further includes a second notch formed in said second lateral surface of said housing.

12. The system of claim 11, wherein said hub further comprises a second latch comprising an engagement surface and a constraining surface facing away from said engagement surface, said second latch being supported for movement between:
an extended position where said constraining surface is disposed in abutment with said second notch to limit movement of said coupler relative to said hub, and
a released position where said second latch is spaced from said second notch to permit movement of said coupler relative to said hub.

13. The system of claim 12, wherein said second latch is coupled to said receiver adjacent to said second side surface such that said constraining surface extends at least partially into said second notch when said second latch is in said extended position to limit movement of said coupler relative to said receiver.

14. The system of claim 5, wherein said front surface is aligned with said rear surface, said first side surface is aligned with said first lateral surface, and said second side surface is aligned with said second lateral surface such that movement of said coupler relative to said receiver of said hub is limited when said housing engages said receiver.

15. The system of claim 5, wherein said front surface is aligned with said rear surface, said first side surface is aligned with said first lateral surface, and said second side surface is aligned with said second lateral surface such that said receiver of said hub shields said coupler from environmental elements when said housing is engaged with said coupler.

16. The system of claim 1, wherein said coupler further comprises a vehicle communication terminal supported by said housing for interfacing with the electric vehicle; and
wherein said hub further comprises a hub communication terminal supported by said receiver, said hub communication terminal arranged to abut said vehicle communication terminal when said receiver engages said housing of said coupler.

17. (canceled)

18. The system of claim 1, wherein said coupler further comprises a vehicle ground terminal supported by said housing for interfacing with the battery of the electric vehicle; and
wherein said hub further comprises a hub ground terminal supported by said receiver, said hub ground terminal being arranged to abut said vehicle ground terminal when said receiver engages said housing of said coupler.

19. (canceled)

20. The system of claim 18, wherein said coupler further comprises a vehicle communication terminal supported by said housing for interfacing with the electric vehicle;
wherein said hub further comprises a hub communication terminal supported by said receiver and arranged to abut said vehicle communication terminal when said receiver engages said housing of said coupler; and
wherein said vehicle power terminal, said vehicle communication terminal, and said vehicle ground terminal are arranged in a spaced relationship about said housing.

21. The system of claim 20, wherein said hub further comprises a hub controller configured to detect parameters associated with the electric vehicle when said housing engages said receiver, and to direct power across the hub power terminal in response to the detected parameters;
wherein said hub further comprises a hub communication terminal supported by said receiver and arranged to abut said vehicle communication terminal when said receiver engages said housing of said coupler; and
wherein said coupler further comprises a vehicle communication terminal supported by said housing for interfacing with the electric vehicle, and a coupler controller disposed in electrical communication with said vehicle communication terminal and configured to transmit parameters associated with the electric vehicle via said vehicle communication terminal across said hub communication terminal to said hub controller when said housing engages said hub.

22. (canceled)

23. A system for use in docking an electric vehicle and for charging a battery of the electric vehicle via a power source, said system comprising:
a coupler comprising:
a housing adapted for attaching to the electric vehicle,
a vehicle power terminal supported by said housing for interfacing with the battery of the electric vehicle, and
a catch spaced from said vehicle power terminal; and
a hub comprising:
a receiver shaped to engage said housing of said coupler,
a hub power terminal supported by said receiver for interfacing with the power source, said hub power terminal arranged to abut said vehicle power terminal when said receiver engages said housing of said coupler,
a latch comprising an engagement surface and a constraining surface facing away from said engagement surface, said latch being supported for movement between: an extended position where said constraining surface is disposed in abutment with said catch to limit movement of said coupler relative to said hub; and a released position where said latch is spaced from said catch to permit movement of said coupler relative to said hub,
a lock mechanism operatively attached to said latch and being operable between: a first configuration placing said latch in said released position to permit said coupler to disengage from said hub; and a second configuration to permit movement of said latch from said extended position to said released position in response to contact occurring between said housing of said coupler and said engagement surface of said latch, and
a biasing element arranged to urge said latch toward said extended position when said lock mechanism operates in said second configuration such that contact occurring between said housing and said engagement surface urges the latch toward said released position as said housing is moved into said receiver, and wherein subsequent movement of said housing into said receiver simultaneously brings said vehicle power terminal into electrical contact with said hub power terminal and aligns said catch with said latch to move said latch to said extended position.

24. A coupler for docking an electric vehicle to a hub for charging a battery of the electric vehicle via a power source, the hub having a receiver, a hub power terminal supported by the receiver, a latch supported by the receiver for movement between an extended position and a released position, and a lock mechanism operatively attached to the latch and being operable between a first configuration and a second configuration to actuate the latch between the extended position and the released position, said coupler comprising:
a housing adapted for attaching to the electric vehicle and shaped to engage the receiver of the hub such that movement of said coupler is limited relative to the receiver when said coupler engages the receiver;
a vehicle power terminal supported by said housing for interfacing with the battery of the electric vehicle, said vehicle power terminal arranged to abut the hub power terminal when said housing engages the receiver of the hub;
a vehicle communication terminal supported by said housing for interfacing with the electric vehicle;
a catch spaced from said vehicle power terminal, wherein said catch is configured to receive the latch when said coupler engages the hub such that movement of said housing into the receiver simultaneously brings said vehicle power terminal into electrical contact with the hub power terminal and aligns said catch with the latch to move the latch to the extended position; and
a coupler controller disposed in electrical communication with said vehicle communication terminal and configured to transmit parameters associated with the electric vehicle across said vehicle communication terminal.

25. (canceled)

26. (canceled)

27. (canceled)

28. (canceled)

29. (canceled)

30. (canceled)

31. (canceled)

32. (canceled)

33. (canceled)
